(19) United States
(12) Patent Application Publication
(10) Pub. No.: US 2018/0031413 A1
(43) Pub. Date: Feb. 1, 2018

(54) FIBER OPTIC DISTRIBUTED ACOUSTIC SENSOR OMNIDIRECTIONAL ANTENNA FOR USE IN DOWNHOLE AND MARINE APPLICATIONS

(71) Applicant: Halliburton Energy Services, Inc., Houston, TX (US)

(72) Inventors: Christopher Lee Stokely, Houston, TX (US); Jesse Choe, Houston, TX (US); David Andrew Barfoot, Houston, TX (US)

(21) Appl. No.: 15/312,131

(22) PCT Filed: Nov. 18, 2015
(86) PCT No.: PCT/US2015/061330

§ 371 Date: Nov. 17, 2016

(51) Int. Cl. G01H 9/00; E21B 47/00; G01V 1/20; G01V 1/22; G01V 1/52

(52) U.S. Cl. CPC G01H 9/004; G01V 1/226; G01V 1/52; G01V 1/208; E21B 47/00; G01V 2210/1429; G01V 2001/526

(57) ABSTRACT

An example omnidirectional sensing system may include a fiber optic cable wrapped around a sphere or spheroid in no preferred direction. The wrapped fiber optic cable may make the system more receptive to acoustic disturbances and increase the fidelity of the sensor in the area of the sphere or spheroid. The system may be used, for instance, for vertical seismic profiling via a wireline technique, placement at the surface of the earth for surface seismic, and in marine applications.

### TECHNICAL FIELD

The present disclosure relates generally to techniques for sensing acoustic information, and more particularly, to the use of fiber optics in distributed acoustic sensors having an omnidirectional antenna for use in downhole and marine applications.

### BACKGROUND

Collecting subsurface data is important to the process of oil and gas drilling. Sensors are often used to collect information such as acoustics, which are particularly useful for monitoring downhole conditions. Fiber optic cables have proven well suited for use in downhole applications. When used for distributed acoustic sensing (DAS), the fiber optic cable itself may form an acoustic sensor. Fiber optic cables are capable of detecting and locating vibration, strain, and other pertinent downhole parameters. Detecting these parameters has a number of applications, including, but not limited to, wellbore interventions, wellbore wireline activities, well completions, reservoir properties, seismic correlations, petrophysics, rock mechanics, and other areas.

Acoustic sensing based on DAS may use the Rayleigh backscatter property of a fiber's optical core and may spatially detect disturbances that are distributed along the fiber length. DAS may also detect reflections from fiber Bragg gratings (FBGs) or fiber optic partial mirrors added to a fiber optic cable. Such systems may rely on detecting phase changes brought about by changes in strain along the fiber's core. Externally-generated acoustic disturbances may create very small strain changes, which translate into phase changes of the reflected light along the optical fiber. Indeed, fiber optic cables are very good sensors since they can pick up very slight changes in a downhole or marine condition. Furthermore, the use of fiber optic cables in downhole and marine environments is also beneficial since they do not experience interference from downhole electrical devices and do not degrade over time.

### BRIEF DESCRIPTION OF DRAWINGS

FIG. 1 is a schematic diagram illustrating examples of different angles of incidence with which vibrations might encounter the surface of a fiber optic cable used as a sensor in accordance with the present disclosure;

FIG. 2 is a schematic diagram of an example system with fiber optic sensors according to the present disclosure may be utilized;

FIG. 3 is a schematic diagram of an example DAS data collection system in accordance with the present disclosure;

FIGS. 4A-B are schematic diagrams of a fiber optic cable wrapped around a sphere to form an omnidirectional sensor in accordance with some embodiments of the present disclosure;

FIG. 5 is a schematic diagram of a fiber optic cable wrapped around a spheroid to form an omnidirectional sensor in accordance with some embodiments of the present disclosure.

FIGS. 6A-B are schematic diagrams illustrating several different ways of multiplexing multiple spheres in accordance with the present disclosure;

FIG. 7 illustrates an embodiment where the multiplexing of multiple fiber optic wrapper spheres in connection with the present disclosure is utilized in a marine application; and

FIG. 8 is a block diagram of an exemplary computing system for use with the acoustic sensors in accordance with the present disclosure.

FIG. 9 is a schematic diagram of an example drilling system with the drill string removed, in accordance with the present disclosure.

FIG. 10 is a diagram of an example completion assembly, in accordance with the present disclosure.

While embodiments of this disclosure have been depicted and described and are defined by reference to exemplary embodiments of the disclosure, such references do not imply a limitation on the disclosure, and no such limitation is to be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### DETAILED DESCRIPTION

To facilitate a better understanding of the present disclosure, the following examples of certain embodiments are given. In no way should the following examples be read to limit, or define, the scope of the invention. Embodiments of the present disclosure may be applicable to horizontal, vertical, deviated, or otherwise nonlinear wellbores in any type of subterranean formation. Embodiments may be applicable to injection wells as well as production wells, including hydrocarbon wells. Embodiments may be implemented using a tool that is made suitable for testing, retrieval and sampling along sections of the formation. Embodiments may be implemented with tools that, for example, may be conveyed through a flow passage in tubular string or using a wireline, slickline, coiled tubing, downhole robot or the like.

The present disclosure describes systems and methods for an omnidirectional fiber optic DAS. DAS data collection systems rely on detecting phase changes in backscattered light signals to determine changes in strain (e.g., caused by acoustic waves or vibrations) along the length of optical fiber. Vibrations traveling at a smaller angle of incidence to perpendicular of the surface of the cable are detected more strongly than vibrations traveling at a larger angle of incidence. Even when arranged on a spool or coil there would be some intrinsic directionality to the fiber optic cable because the arrangement is not spherically symmetric. By wrapping the cable in the shape of a sphere or spheroid, that directionality may be reduced or eliminated.

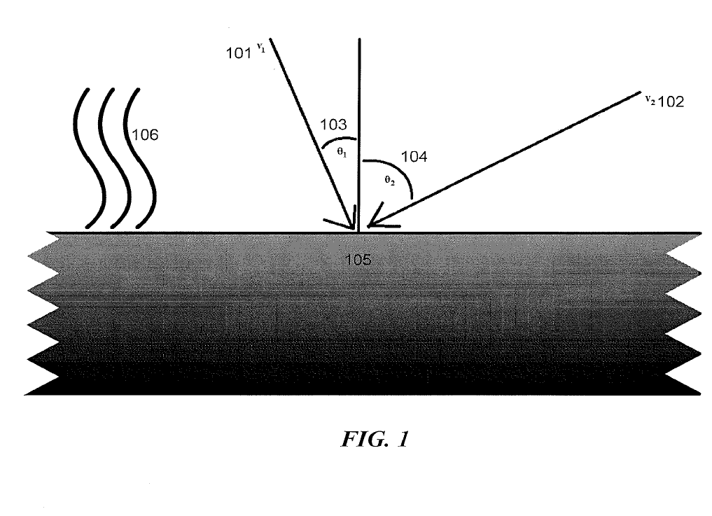

To facilitate a better understanding of the present disclosure, the following examples of certain embodiments are given. In no way should the following examples be read to limit, or define, the scope of the disclosure. Embodiments of the present disclosure and its advantages are best understood by referring to FIGS. 1 through 10, where like numbers are used to indicate like and corresponding parts.

FIG. 1 illustrates vibrations and temperature changes inducing detectable disturbances along a fiber optic cable. Vibration v₁ 101 has a smaller angle of incidence 103 to the surface of the fiber optic cable 105 than equivalent vibration v₂ 102, which forms an angle of incidence 104. Therefore, vibration v₁ 101 will be detected more strongly than vibration v₂ 102. By wrapping the fiber optic cable around spheres or spheroids located at intervals along its length, the surface of the cable is omnidirectional, which may better enable the cable to detect vibrations because a small angle of incidence will exist between the vibrations and at least one direction in which the surface of the cable is oriented. Wrapping the fiber optic cable 105 around the spheres or spheroids may also allow better detection of changes in temperature 106. Wrapping additional fiber optic cable around the sphere or spheroid also has the effect of increasing fidelity of the sensor in the area of the sphere or spheroid.

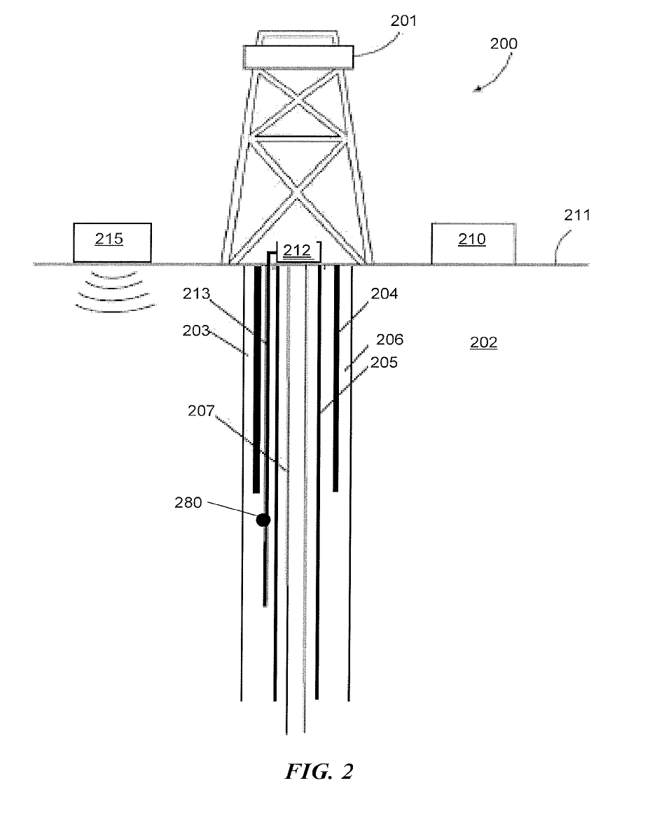

FIG. 2 illustrates an example completed well system 200 incorporating a DAS data collection system 212, in accordance with embodiments of the present disclosure. The system 200 includes a rig 201 located at a surface 211 and positioned above a wellbore 203 within a subterranean formation 202. One or more tubulars are positioned within the wellbore 203 in a telescopic fashion. As depicted, the tubulars comprise a surface casing 204 and a production casing 205. The surface casing 204 comprises the largest tubular and is secured in the wellbore 203 via a cement layer 206. The production casing 205 is at least partially positioned within the surface casing 204 and may be secured with respect to the formation 202 and the surface casing 204 via a casing hangar (not shown) and a cement layer. The system 200 further includes tubing 207 positioned within the production casing 205. Other configurations and orientations of tubulars within the wellbore 203 are possible.

As depicted, the DAS data collection system 212 is located at the surface 211. The DAS system 212 may be coupled to an fiber optic cable 213 that is at least partially positioned within the wellbore 103. As depicted, the cable 213 is positioned between the surface casing 204 and the production casing 205 and is wrapped around at least one sphere 280. The cable 213 may be secured in place between the surface casing 204 and the production casing 205 such that it functions as a “permanent” seismic sensor. In other embodiments, the cable 213 may be secured to the tubing 207, for instance, lowered into the wellbore 203 through the inner bore of the tubing 207 in a removable wireline arrangement, or positioned at any other suitable position.

Although illustrated as including one DAS system 212 coupled to cable 213, any suitable number of DAS systems 212 (each coupled to cable 213 located downhole) may be placed inside or adjacent to wellbore 203. With cable 213 positioned inside a portion of wellbore 203, DAS system 212 may obtain information associated with formation 202 based on disturbances caused by one or more seismic sources, including an artificial seismic source 215 positioned at the surface. Some examples of artificial seismic sources may include explosives (e.g., dynamite), air guns, thumper trucks, or any other suitable vibration source for creating seismic waves in formation 202. DAS system 212 may thus be configured to collect seismic data along the length of cable 213 based on determined phase changes in light signals. Example DAS systems 212 and their functionality are described further below.

As depicted, the system 200 further includes an information handling system 210 positioned at the surface 211. The information handling system 210 may be communicably coupled to the DAS 212 through, for instance, a wired or wireless connection. The information handling system 210 may receive seismic measurements from the DAS 212 and perform one or more actions that will be described in detail below. The information handling system 210 may comprise a processor and a memory device coupled to the processor, with the memory device containing a set of instructions that cause the processor to perform the actions. Although the information handling system 210 is shown near the wellbore 203, it may also be located remotely. Additionally, the information handling system 210 may receive seismic measurements from a data center or storage server in which the measurements from the DAS 212 were previously stored.

Modifications, additions, or omissions may be made to FIG. 2 without departing from the scope of the present disclosure. For example, the DAS systems and cables may be used during wireline or slickline logging operations before some or all of the tubulars have been secured within the wellbore, and/or before the wellbore 203 is completed. As another example, multiple seismic sources 215 may be used in conjunction with system 200 and DAS system 212. Moreover, components may be added to or removed from system 200 without departing from the scope of the present disclosure.

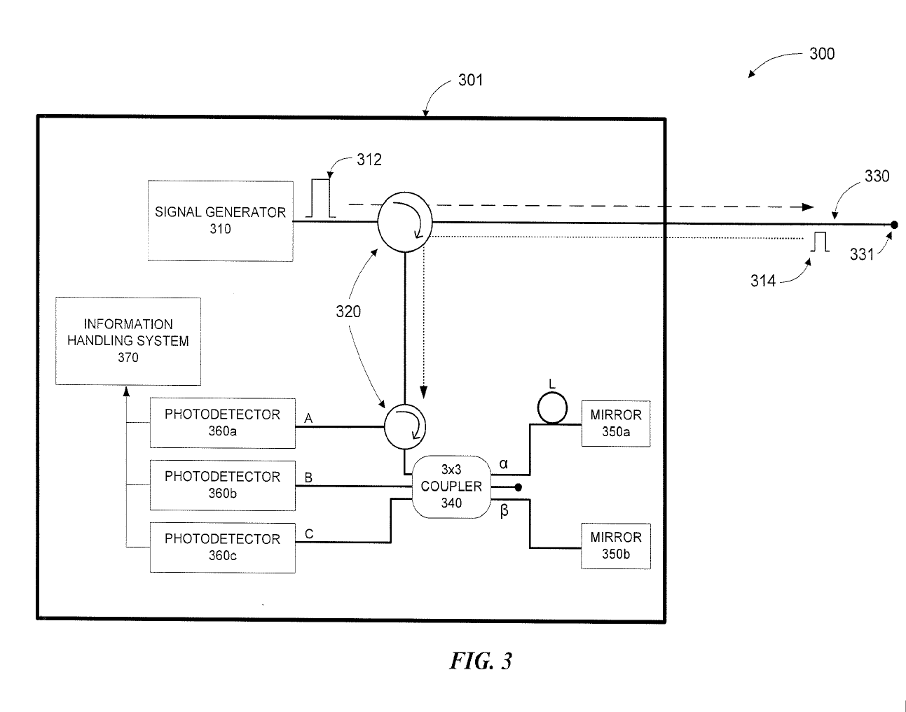

FIG. 3 illustrates an example DAS data collection system 300, in accordance with embodiments of the present disclosure. DAS data collection system 300 may be used for measuring dynamic strain, acoustics, or vibration downhole in a completed well system such as completed well system 200 of FIG. 2. For example, DAS data collection system 300 may be coupled to components of completed well system similar to completed well system 200 in order to detect disturbances in the system and/or seismic information for the surrounding formation.

DAS data collection system 300 comprises DAS box (optoelectronic interrogator) 301 coupled to sensing fiber 330. DAS box 301 may be a physical container that comprises optical components suitable for performing DAS techniques using optical signals 312 transmitted through sensing fiber 330, including signal generator 310, circulators 320, coupler 340, mirrors 350a-350b, photodetectors 360a-360c, and information handling system 370 (all of which are communicably coupled with optical fiber), while sensing fiber 330 may be any suitable optical fiber for performing DAS measurements. DAS box 301 and sensing fiber 330 may be located at any suitable location for detecting disturbances or vibrations. For example, in some embodiments, DAS box 301 may be located at the surface of the wellbore with sensing fiber 330 coupled to one or more components of the drilling system, such as a mud pump, a mud return tube, and a drill string.

Signal generator 310 may include a laser and associated opto-electronics for generating optical signals 312 that travel down sensing fiber 330. Signal generator 310 may be coupled to one or more circulators 320 inside DAS box 301. In certain embodiments, optical signals 312 from signal generator 310 may be amplified using optical gain elements, such as any suitable amplification mechanisms including, but not limited to, Erbium Doped Fiber Amplifiers (EDFAs) or Semiconductor Optical Amplifiers (SOAs). Optical signals 312 may be highly coherent, narrow spectral line width interrogation light signals in particular embodiments.

As optical signals 312 travel down sensing fiber 330 as illustrated in FIG. 3, imperfections in the sensing fiber 330 may cause portions of the light to be backscattered along the sensing fiber 330 due to Rayleigh scattering. Scattered light according to Rayleigh scattering is returned from every point along the sensing fiber 330 along the length of the sensing fiber 330 and is shown as backscattered light 314 in FIG. 3. This backscatter effect may be referred to as Rayleigh backscatter. Density fluctuations in the sensing fiber 330 may give rise to energy loss due to the scattered light, with the following coefficient:

$${α}_{scat} = \frac{8 {π}^{3}}{3 {λ}^{4}} {n}^{8} {p}^{2} {kT}_{f} β$$

where n is the refraction index, p is the photoelastic coefficient of the sensing fiber 230, k is the Boltzmann constant, and is the isothermal compressibility. T₁ is a fictive temperature, representing the temperature at which the density fluctuations are “frozen” in the material. In certain embodiments, sensing fiber 330 may be terminated with low reflection device 331. In some embodiments, the low reflection device may be a fiber coiled and tightly bent such that all the remaining energy leaks out of the fiber due to macrobending. In other embodiments, low reflection device 331 may be an angle cleaved fiber. In still other embodiments, the low reflection device 331 may be a coreless optical fiber. In still other embodiments, low reflection device 331 may be a termination, such as an AFL ENDLIGHT. In still other embodiments, sensing fiber 330 may be terminated in an index matching gel or liquid.

Backscattered light 314 may consist of an optical light wave or waves with a phase that is altered by changes to the optical path length at some location or locations along sensing fiber 330 caused by vibration or acoustically induced strain. By sensing the phase of the backscattered light signals, it is possible to quantify the vibration or acoustics along sensing fiber 330. An example method of detecting the phase of the backscattered light is through the use of a 3×3 coupler, as illustrated in FIG. 3 as coupler 340. Backscattered light 314 travels through circulator 320 toward coupler 340, which may split backscattered light 314 among at least two paths (i.e., paths α and β in FIG. 3). One of the two paths may comprise an additional length L beyond the length of the other path. The split backscattered light 314 may travel down each of the two paths, and then be reflected by mirrors 350a-350b. Mirrors 350 may include any suitable optical reflection device, such as a Faraday rotator mirror. The reflected light from mirrors 350 may then be combined in coupler 340 and passed toward photodetectors 360a-360c. The backscattered light signal at each of photodetectors 360a-360c will contain the interfered light signals from the two paths (α and β ), with each signal having a relative phase shift of 120 degrees from the others. The signals at photodetectors 360a-360c may be passed to information handling system 370 for analysis. Information handling system 370 may be located at any suitable location, and may be located downhole, uphole (e.g., in control unit 210 of FIG. 2), or in a combination thereof. In particular embodiments, information handling system 370 may measure the interfered signals at photodetectors 360a-360c having three different relative phase shifts of 0, +120, and −120 degrees, and accordingly determine the phase difference between the backscattered light signals along the two paths. This phase difference determined by information handling system 370 may be used to measure strain on sensing fiber 330 caused by vibrations in a formation. By sampling the signals at photodetectors 360a-360c at a high sample rate, various regions along sensing fiber 330 may be sampled, with each region being the length of the path mismatch L between paths α and β.

The below equations may define the light signal received by photodetectors 360a-360c:

$$a = k + {P}_{α} cos ( 2 π ft ) + {P}_{β} cos ( 2 π ft + φ )$$

$$b = k + {P}_{α} cos ( 2 π ft ) + {P}_{β} cos ( 2 π ft + φ + \frac{2 π}{3} )$$

$$c = k + {P}_{α} cos ( 2 π ft ) + {P}_{β} cos ( 2 π ft + φ - \frac{2 π}{3} )$$

where a represents the signal at photodetector 360a, b represents the signal at photodetector 360b, c represents the signal at photodetector 360c, f represents the optical frequency of the light signal, φ=optical phase difference between the two light signals from the two arms of the interferometer, P_{α} and P_{β} represent the optical power of the light signals along paths α and β, respectively, and k represents the optical power of non-interfering light signals received at the photodetectors (which may include noise from an amplifier and light with mismatched polarization which will not produce an interference signal). In embodiments where photodetectors 360a-360c are square law detectors with a bandwidth much lower than the optical frequency (e.g., less than 1 GHz), the signal obtained from the photodetectors may be approximated by the below equations:

$$A = \frac{1}{2} ( 2 {k}^{2} + {P}_{α}^{2} + 2 {P}_{α} {P}_{β} cos ( φ ) + {P}_{β}^{2} )$$

$$B = \frac{1}{2} ( 2 {k}^{2} + {P}_{α}^{2} + {P}_{β}^{2} - {P}_{α} {P}_{β} ( cos ( φ ) + \sqrt{3} sin ( φ ) ) )$$

$$C = \frac{1}{2} ( 2 {k}^{2} + {P}_{α}^{2} + {P}_{β}^{2} + {P}_{α} {P}_{β} ( - cos ( φ ) + \sqrt{3} sin ( φ ) ) )$$

where A represents the approximated signal at photodetector 360a, B represents the approximated signal at photodetector 360b, and C represents the approximated signal at photodetector 360c. It will be understood by those of skill in the art that the terms in the above equations that contain φ are the terms that provide relevant information about the optical phase difference since the remaining terms involving the power (k, P_{α}, and P_{β}) do not change as the optical phase changes. The terms above and the structure of the DAS system in which they are utilized are not intended to be limiting, however, as this is only one of many possible DAS systems.

In particular embodiments, quadrature processing may be used to determine the phase shift between the two signals. A quadrature signal may refer to a two-dimensional signal whose value at some instant in time can be specified by a single complex number having two parts: a real (or in-phase) part and an imaginary (or quadrature) part. Quadrature processing may refer to the use of the quadrature detected signals at photodetectors 360a-360c. For example, a phase modulated signal y(t) with amplitude A, modulating phase signal 0(t), and constant carrier frequency fmay be represented as:

y(t)=A sin(2πft+θ(t))

or

y(t)=I(t) sin(2πft)+Q(t)cos(2πft)

where

I(t)≡A cos(θ(t))

Q(t)≡A sin(θ(t))

Mixing the signal y(t) with a signal at the carrier frequency f results in a modulated signal at the baseband frequency and at 2f, wherein the baseband signal may be represented as follows:

y(t)e^{iθ(t)}=I(t)+i*Q(t)

Because the Q term is shifted by 90 degrees from the I term above, the Hilbert transform may be performed on the I term to get the Q term. Thus, where [symbol] (·) represents the Hilbert transform:

Q(t)= [symbol] (I(t))

The amplitude and phase of the signal may be represented by the following equations:

$$\vert y ( t ) \vert = \sqrt{{I ( t )}^{2} + {Q ( t )}^{2}}$$

$$θ ( t ) = arctan ( \frac{Q ( t )}{I ( t )} )$$

It will be understood by those of skill in the art that for signals A, B, and C above, the corresponding quadrature I and Q terms may be represented by the following equations:

$$I = A + B - 2 C = \frac{3}{2} {P}_{α} {P}_{β} ( cos ( φ ) - \sqrt{3} sin ( φ ) ) = 3 {P}_{α} {P}_{β} cos ( φ + \frac{π}{3} )$$

$$Q = \sqrt{3} ( A - B ) = \frac{3}{2} {P}_{α} {P}_{β} ( \sqrt{3} cos ( φ ) + sin ( φ ) ) = 3 {P}_{α} {P}_{β} sin ( φ + \frac{π}{3} )$$

wherein the phase shift, which is shifted by π/3, is represented by:

$$φ = arctan ( \frac{Q}{I} ) - \frac{π}{3}$$

Accordingly, the phase of the backscattered light in sensing fiber 330 may be determined using the quadrature representations of the DAS data signals received at photodetectors 360. This allows for an elegant way to arrive at the phase using the quadrature signals inherent to the DAS data collection system.

Modifications, additions, or omissions may be made to FIG. 3 without departing from the scope of the present disclosure. For example, FIG. 3 shows a particular configuration of components of system 300. However, any suitable configuration of components configured to detect the optical phase and/or amplitude of coherent Rayleigh backscatter in optical fiber using spatial multiplexing (i.e., monitoring different locations, or channels, along the length of the fiber) may be used. For example, although optical signals 312 are illustrated as pulses, DAS data collection system 300 may transmit continuous wave optical signals 312 down sensing fiber 330 instead of, or in addition to, optical pulses. As another example, the measurement of acoustic disturbances in the optical fiber may be accomplished using FBGs embedded in the optical fiber. As yet another example, an interferometer may be placed in the launch path (i.e., in a position that splits and interferes optical signals 312 prior to traveling down sensing fiber 330) of the interrogating signal (i.e., the transmitted optical signal 312) to generate a pair of signals that travel down sensing fiber 330, as opposed to the use of an interferometer further downstream as shown in FIG. 3.

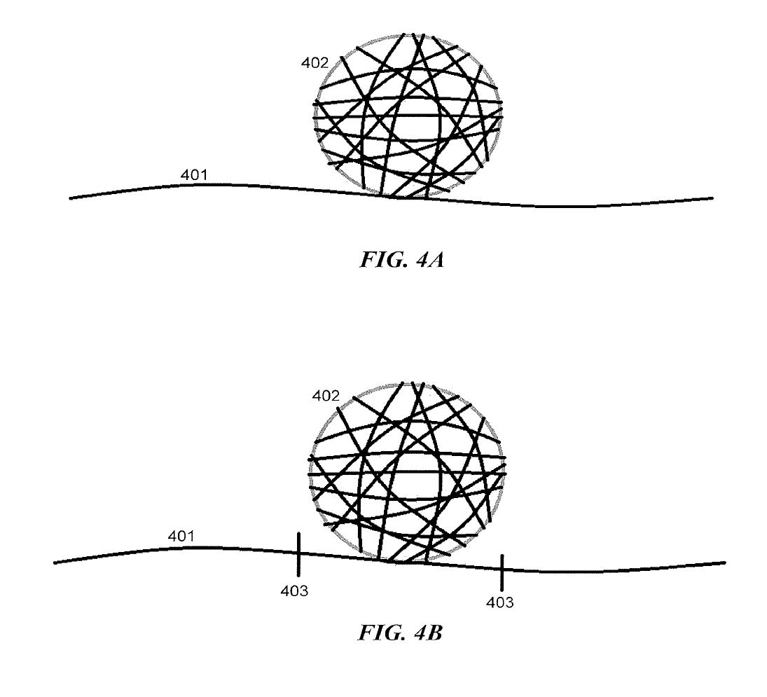

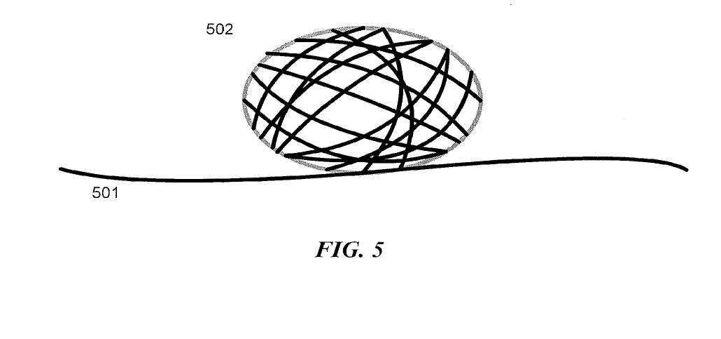

Turning now to the fiber optic sensors, FIGS. 4A-4B illustrate example fiber-wrapped sensors in accordance with embodiments of the present disclosure. FIG. 4A illustrates an example portion of a fiber optic cable 401 that has been wrapped repeatedly, in no preferred direction, around a sphere 402. The fiber optic cable may be coupled with a DAS system (330 of FIG. 3). The sensor may consist of one or more fiber optic cables 401 that have no preferred directionality. The cable 401's diameter should be smaller than the acoustic wavelengths of interest. The cable 401 should be wrapped around a sphere 402 with a smaller diameter than the acoustic wavelengths of interest. The wrapping may be random or uniform. The cable 401 should be wrapped so as to measure three orthogonal directions. The sphere 402 may be made out of a compliant material. For example, the sphere may but are not required to be made out of thermoplastic polymers (TPU's) and thermoplastic elastomers (TPE's), which exhibit a combination of a low Young's modulus (E) and a low Poisson ratio (sigma). The Poisson's ratio may be preferably below 0.5, which is the Poisson's ratio of natural rubber. FIG. 5 illustrates another example in accordance with the present disclosure, wherein the fiber optic cable 501 may be wrapped around a spheroid 502, instead of a sphere (402 of FIG. 4), as long as the same wrapping parameters are achieved.

FIG. 4B illustrates another exemplary embodiment of the fiber optic sensors in accordance with the present disclosure, wherein a pair of reflecting elements 403 is placed at each end of the sphere 402 where the fiber 401 enters and exits. This configuration enhances the signal-to-noise (SNR) ratio of the sensor. The reflecting elements 403 may be FBGs or any other refractive index change mechanism that generates a reflection. In particular embodiments, the sensors may be multiplexed by time division (TDM), wavelength division (WDM), or both.

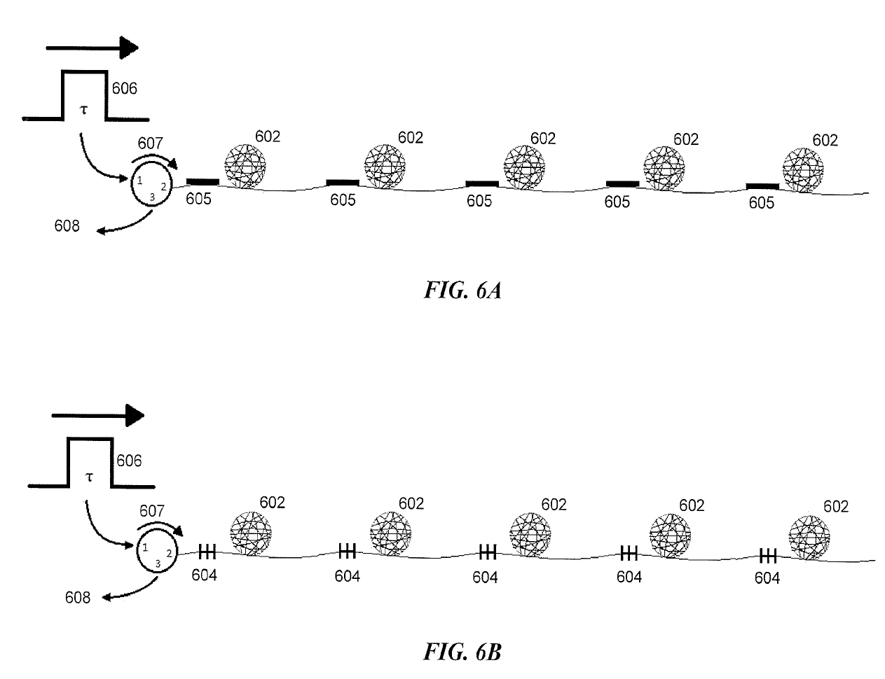

FIGS. 6A-6B illustrate example embodiments of fiber optic sensors in accordance with the present disclosure that utilize reflecting elements to create a multiplexed sensor configuration. FIG. 6A illustrates an exemplary embodiment wherein a plurality of fiber-wrapped spheres 602 are placed along the fiber optic cable so as to create a multiplexed configuration. Partial reflectors 605 are placed on the surface of the fiber optic cable between the each of the fiber-wrapped spheres 602. FIG. 6B illustrates an example of multiplexing using FBGs 604 placed between each of the plurality of fiber-wrapped spheres 602. With TDM, the light pulse 606 travels down the cable, reflecting off the reflectors 605 or FBGs 604. The optical circulator 607 separates the incoming light for processing 608 by a DAS system, an example of which is shown and described in connection with FIG. 3. With WDM, the different reflectors 605 or FBGs 604 may reflect different wavelengths of light. The TDM and WDM methods may be combined to achieve higher numbers of sensors than would be possible with either method individually.

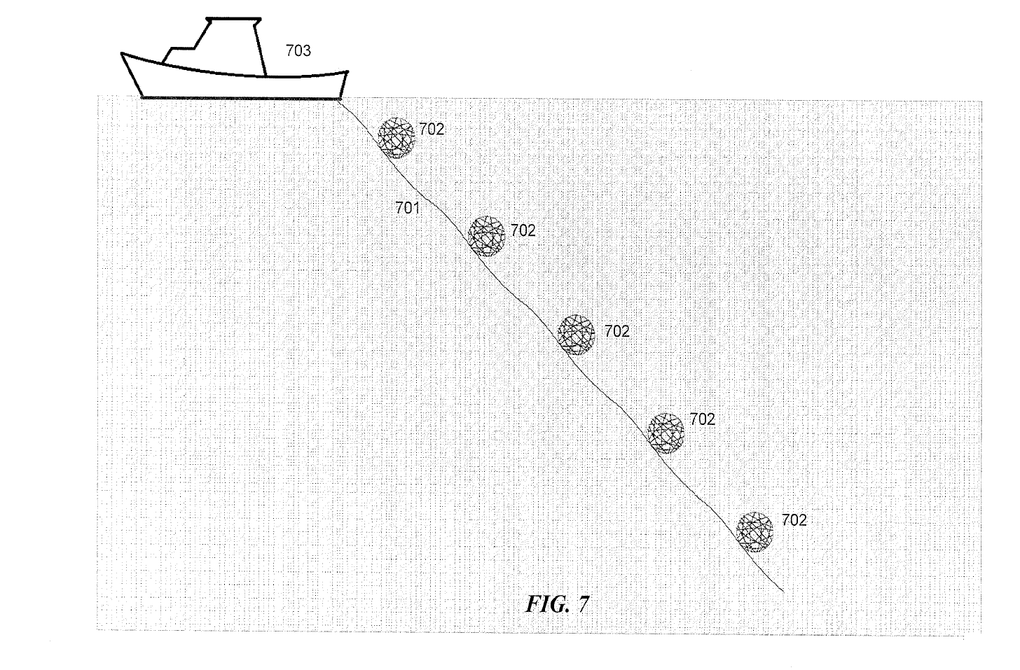

In particular embodiments, the sensors may be tethered to a marine vessel in order to detect disturbances in marine environments. FIG. 7 illustrates an example of a fiber optic cable 701 wrapped around a one or more spheres 702 tethered to a marine vessel 703. The DAS may be located on the marine vessel 703. In particular embodiments, in addition to detecting strain and vibrations, DAS may also be used to detect parameters related to strain. For instance, changes in temperature (106 of FIG. 1) may induce disturbances that can be detected by the DAS. Wrapping fiber optic cable (401 of FIG. 4A) around the sphere (402 of FIG. 4A) or spheroid (502 of FIG. 5) improves detection of those parameters related to strain, such as temperature.

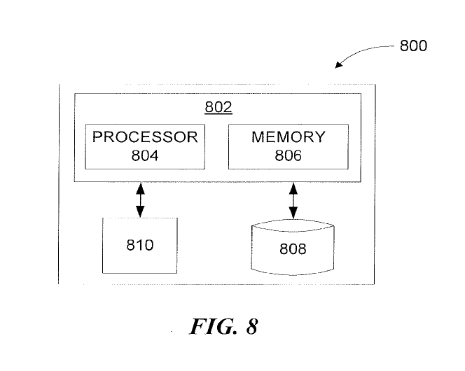

FIG. 8 illustrates a block diagram of an exemplary computing system 800 for use with drilling system 200 of FIG. 2, or DAS data collection system 300 of FIG. 3, in accordance with embodiments of the present disclosure. Computing system 800 or components thereof can be located at the surface (e.g., in control unit 210 of FIG. 2), downhole (e.g., in BHA 206 and/or in LWD/MWD apparatus 207 of FIG. 2), or some combination of both locations (e.g., certain components may be disposed at the surface while certain other components may be disposed downhole, with the surface components being communicatively coupled to the downhole components). If the fiber optic cable and spheres are tethered to a marine vessel, the computing system 800 may be located on the marine vessel (703 of FIG. 7).

Computing system 800 may be configured to detect vibrations or disturbances, in a downhole drilling system, in accordance with the teachings of the present disclosure. In particular embodiments, computing system 800 may include acoustic detection module 802. Acoustic detection module 802 may include any suitable components. For example, in some embodiments, acoustic detection module 802 may include processor 804. Processor 804 may include, for example a microprocessor, microcontroller, digital signal processor (DSP), application specific integrated circuit (ASIC), or any other digital or analog circuitry configured to interpret and/or execute program instructions and/or process data. In some embodiments, processor 804 may be communicatively coupled to memory 806. Processor 804 may be configured to interpret and/or execute program instructions or other data retrieved and stored in memory 806. Program instructions or other data may constitute portions of software 808 for carrying out one or more methods described herein. Memory 806 may include any system, device, or apparatus configured to hold and/or house one or more memory modules; for example, memory 806 may include read-only memory (ROM), random access memory (RAM), solid state memory, or disk-based memory. Each memory module may include any system, device or apparatus configured to retain program instructions and/or data for a period of time (e.g., computer-readable non-transitory media). For example, instructions from software 808 may be retrieved and stored in memory 806 for execution by processor 804.

In particular embodiments, acoustic detection module 802 may be communicatively coupled to one or more displays 810 such that information processed by acoustic detection module 802 may be conveyed to operators of drilling equipment. For example, acoustic detection module 802 may convey information related to the detection of acoustics (e.g., timing between the detected mud pulses) to display 810.

Modifications, additions, or omissions may be made to FIG. 8 without departing from the scope of the present disclosure. For example, FIG. 8 shows a particular configuration of components of computing system 800. However, any suitable configurations of components may be used. For example, components of computing system 800 may be implemented either as physical or logical components. Furthermore, in some embodiments, functionality associated with components of computing system 800 may be implemented in special purpose circuits or components. In other embodiments, functionality associated with components of computing system 800 may be implemented in configurable general purpose circuit or components. For example, components of computing system 800 may be implemented by configured computer program instructions.

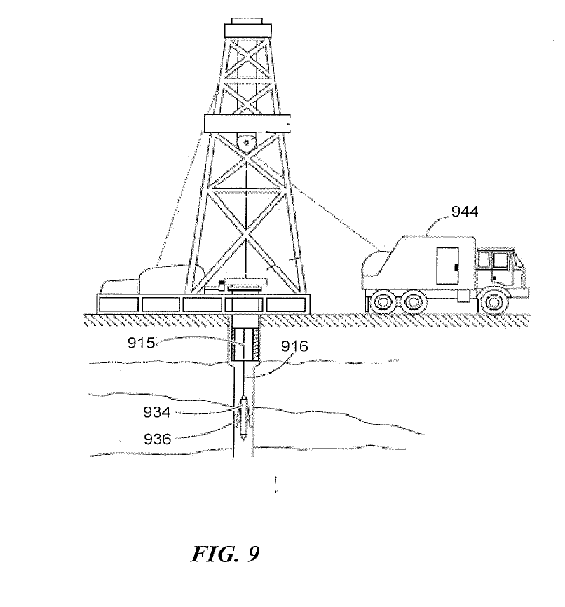

FIG. 9 illustrates a schematic diagram of a wireline tool. At various times during the drilling process, the drill string (205 of FIG. 2) may be removed from the wellbore 916 (203 of FIG. 2). Once the drill string (205 of FIG. 2) has been removed, measurement/logging operations can be conducted using a wireline tool 934, i.e., an instrument that is suspended into the borehole 916 by a cable 915 having conductors for transporting power to the tool from a surface power source, and telemetry from the tool body to the surface. The wireline tool 934 may comprise electronic components similar to the electronic components described above. For instance, the wireline tool 934 may comprise logging and measurement elements 936. The elements 936 may be communicatively coupled to the cable 915. A logging facility 944 (shown in FIG. 9 as a truck, although it may be any other structure) may collect measurements from the tool 936, and may include computing facilities (including, e.g., a control unit/information handling system) for controlling, processing, storing, and/or visualizing the measurements gathered by the elements 936. In certain embodiments, the elements 936 may include an acoustic sensor comprising a fiber optic cable wrapped around one or more spheres or spheroids, as described above. The sensor may be coupled with a DAS (300 of FIG. 3), which may be located in the logging facility 934. The computing facilities may be communicatively coupled to the elements 936 by way of the cable 915. In certain embodiments, the computing system (800 of FIG. 8) may serve as the computing facilities of the logging facility 944.

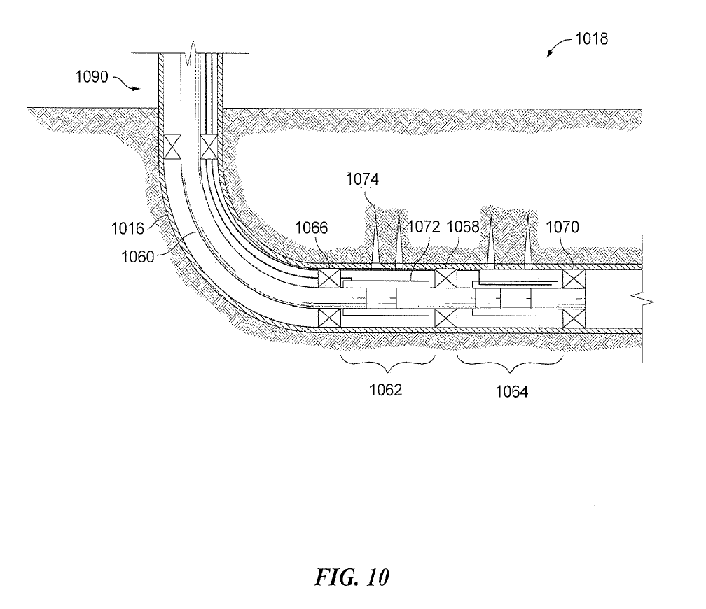

FIG. 10 illustrates an example completion assembly 1090 within the wellbore 1016, according to aspects of the present disclosure. Once the wellbore 1016 reaches a desired depth, completion operations may be undertaken to prepare the wellbore 1016 to produce hydrocarbons. Completion operations may include, but are not limited to, hydraulic fracturing, perforation, and formation isolation. In order to detect disturbances along the completion assembly 1090, a fiber optic cable wrapped around a plurality of spheres or spheroids may be attached to the completion assembly 1090 and used as a sensor. As depicted, the assembly 1090 includes a production tubular 1060 coupled between the surface (not shown) of the formation 1018, and completion stages 1062 and 1064. The completion stages 1062 and 1064 may but are not required to comprise portions of the wellbore 1016 and formation 1018 isolated by packers 1066-70. As depicted, each completion stage 1062 and 1064 isolates a fractured portion of the formation 1018. Stage 1062, for instance, comprises at least one remotely actuatable valve 1072 that selectively isolates the fractured portion 1074 of the formation 1018 from the production tubular 1060. As depicted, one or more control lines may extend from the valve 1072 to the surface to provide control of the valve 1072. The valve 1072 may comprise an electrical component. The completion stages 1062 and 1064 as well as other completion tools may comprise electrical components similar to the ones described above. When opened, the valve 1072 may provide fluid communication between the fracture 1074 and the production tubular, such that hydrocarbons may be produced to the surface.

An omnidirectional sensing system, comprising a fiber optic cable wrapped around at least one sphere, a light source coupled to the fiber optic cable, and an optoelectronic interrogator coupled to the fiber optic cable is disclosed. An omnidirectional sensing system, comprising a fiber optic cable wrapped around at least one spheroid, in no preferred direction, the spheroid forming an acoustic sensor, a light source coupled to the fiber optic cable, and an optoelectronic interrogator coupled to the fiber optic cable is also disclosed. A method of sensing a disturbance and its location, comprising directing a light source into a fiber optic cable which is wrapped around at least one sphere or at least one spheroid in no preferred direction, detecting reflected light with an optoelectronic interrogator, and analyzing and recording the disturbance and its location based on the time domain information collected by the interrogator is also disclosed.

In any of the embodiments described in this or the preceding paragraph, the omnidirectional sensing system may comprise a plurality of spheres around which the fiber optic cable is wrapped. In any of the embodiments described in this or the preceding paragraph, the plurality of spheres may be disposed downhole within a wellbore of a subterranean formation. In any of the embodiments described in this or the preceding paragraph, the plurality of spheres may be tethered to a marine vessel. In any of the embodiments described in this or the preceding paragraph, the fiber optic cable may form an acoustic antenna and at least one sphere may enhance the sensitivity of the sensing system. In any of the embodiments described in this or the preceding paragraph, the fiber optic cable may form a sensor to detect changes in temperature and at least one sphere may enhance sensitivity of the sensing system. In any of the embodiments described in this or the preceding paragraph, the fiber optic cable may form a vibration sensor and at least one sphere may enhance the sensitivity of the sensing system. In any of the embodiments described in this or the preceding paragraph, the fiber optic cable may form a pressure sensor and at least one sphere may enhance the sensitivity of the sensing system. In any of the embodiments described in this or the preceding paragraph, the optoelectronic interrogator may be remote from at least one of the spheres.

In any of the embodiments described in this or the preceding two paragraphs, the omnidirectional sensing system may comprise a plurality of spheroids around which the fiber optic cable is wrapped. In any of the embodiments described in this or the preceding two paragraphs, the plurality of spheroids may be disposed downhole within a wellbore of a subterranean formation. In any of the embodiments described in this or the preceding two paragraphs, the plurality of spheroids may be tethered to a marine vessel. In any of the embodiments described in this or the preceding two paragraphs, the fiber optic cable may form an acoustic antenna and at least one spheroid may enhance the sensitivity of the sensing system. In any of the embodiments described in this or the preceding two paragraphs, the fiber optic cable may form a sensor to detect changes in temperature and at least one spheroid may enhance sensitivity of the sensing system. In any of the embodiments described in this or the preceding two paragraphs, the fiber optic cable may form a vibration sensor and at least one spheroid may enhance the sensitivity of the sensing system. In any of the embodiments described in this or the preceding two paragraphs, the fiber optic cable may form a pressure sensor and at least one spheroid may enhance the sensitivity of the sensing system. In any of the embodiments described in this or the preceding two paragraphs, the optoelectronic interrogator may be remote from at least one of the spheroids.

In any of the embodiments described in this or the preceding three paragraphs, reflected light may be detected by detecting coherent Rayleigh backscatter from the fiber optic cable. In any of the embodiments described in this or the preceding three paragraphs, reflected light may be detected by detecting light reflected from Bragg gratings distributed along the fiber optic cable. In any of the embodiments described in this or the preceding three paragraphs, light may be detected by detecting light reflected from fiber optic partial mirrors distributed along the fiber optic cable.

Illustrative embodiments of the present disclosure are described in detail herein. In the interest of clarity, not all features of an actual implementation may be described in this specification. It will of course be appreciated that in the development of any such actual embodiment, numerous implementation-specific decisions may be made to achieve the specific implementation goals, which may vary from one implementation to another. Moreover, it will be appreciated that such a development effort might be complex and time-consuming, but would nevertheless be a routine undertaking for those of ordinary skill in the art having the benefit of the present disclosure.

The terms “couple” or “couples” as used herein are intended to mean either an indirect or a direct connection. Thus, if a first device couples to a second device, that connection may be through a direct connection, or through an indirect electrical or mechanical connection via other devices and connections. The term “upstream” as used herein means along a flow path towards the source of the flow, and the term “downstream” as used herein means along a flow path away from the source of the flow. The term “uphole” as used herein means along the drill string or the hole from the distal end towards the surface, and “downhole” as used herein means along the drill string or the hole from the surface towards the distal end.

The present disclosure is therefore well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present disclosure. Also, the terms in the claims have their plain, ordinary meaning unless otherwise explicitly and clearly defined by the patentee.

What is claimed is:

1. A omnidirectional sensing system, comprising:
(a) a fiber optic cable wrapped around at least one sphere,
(b) a light source coupled to the fiber optic cable; and
(c) an optoelectronic interrogator coupled to the fiber optic cable.

2. The omnidirectional sensing system of claim 1, further comprising a plurality of spheres around which the fiber optic cable is wrapped.

3. The omnidirectional sensing system of claim 2, wherein the plurality of spheres are disposed downhole within a wellbore of a subterranean formation.

4. The omnidirectional sensing system of claim 2, wherein the plurality of spheres are tethered to a marine vessel.

5. The omnidirectional sensing system of claim 1, wherein the fiber optic cable forms an acoustic antenna and the at least one sphere enhances the sensitivity of the sensing system.

6. The omnidirectional sensing system of claim 1, wherein the fiber optic cable forms a sensor to detect changes in temperature and the at least one sphere enhances sensitivity of the sensing system.

7. The omnidirectional sensing system of claim 1, wherein the fiber optic cable forms a vibration sensor and the at least one sphere enhances the sensitivity of the sensing system.

8. The omnidirectional sensing system of claim 1, wherein the fiber optic cable forms a seismic sensor and the at least one sphere enhances the sensitivity of the sensing system.

9. The omnidirectional sensing system of claim 1, wherein the optoelectronic interrogator is remote from the at least one sphere.

10. An omnidirectional sensing system, comprising:
(a) a fiber optic cable wrapped around at least one spheroid, in no preferred direction, the spheroid forming an acoustic sensor;
(b) a light source coupled to the fiber optic cable; and
(c) an optoelectronic interrogator coupled to the fiber optic cable.

11. The omnidirectional sensing system of claim 10, further comprising a plurality of spheroids around which the fiber optic cable is wrapped in no preferred direction.

12. The omnidirectional sensing system of claim 11, wherein the plurality of spheroids are disposed downhole within a wellbore of a subterranean formation.

13. The omnidirectional sensing system of claim 11, wherein the plurality of spheroids are tethered to a marine vessel.

14. The omnidirectional sensing system of claim 10, wherein the fiber optic cable forms an acoustic antenna and the at least one spheroid enhances the sensitivity of the sensing system.

15. The omnidirectional sensing system of claim 10, wherein the fiber optic cable forms one of a temperature sensor, vibration sensor or a seismic sensor and the at least one spheroid enhances sensitivity of the sensing system.

16. The omnidirectional sensing system of claim 10, wherein the optoelectronic interrogator is remote from the at least one spheroid.

17. A method of sensing a disturbance and its location, comprising:
(a) directing a light source into a fiber optic cable which is wrapped around at least one sphere or at least one spheroid in no preferred direction;
(b) detecting reflected light with an optoelectronic interrogator; and
(c) analyzing and recording the disturbance and its location based on time domain information collected by the interrogator.

18. The method according to claim 17, wherein the step of detecting reflected light comprises detecting coherent Rayleigh backscatter from the fiber optic cable.

19. The method according to claim 17, wherein the step of detecting reflected light comprises detecting light reflected from Bragg gratings distributed along the fiber optic cable.

20. The method according to claim 17, wherein the step of detecting reflected light comprises detecting light reflected from fiber optic partial mirrors distributed along the fiber optic cable.
